(19) United States
(12) Patent Application Publication
(10) Pub. No.: US 2007/0122287 A1
(43) Pub. Date: May 31, 2007

(54) Fan blade assembly

(76) Inventor: Donald R. Pennington, Kingston, IL (US)

Correspondence Address: MICHAEL BEST & FRIEDRICH, LLP, 100 E WISCONSIN AVENUE, Suite 3300, MILWAUKEE, WI, 53202, US

(21) Appl. No.: 11/288,967

(22) Filed: Nov. 29, 2005

(51) Int. Cl. B64C 27/46

(52) U.S. Cl. 416/223 R

(57) ABSTRACT

Some embodiments of the present invention provide a fan having fan blades shaped to at least partially wrap around a motor driving the fan. In some embodiments, the shape of the fan blade can be at least partially defined by a range of gap sizes between the fan blade and the motor at a location between opposite ends of the motor, the shape of the trailing edge of the fan blade, radial and circumferential camber-to-chord ratios of the fan blade, fan blade twist, and/or fan blade pitch.

### BACKGROUND OF THE INVENTION

Conventional fan blades are typically shaped to generate a desired level of airflow based upon a number of different fan blade parameters. These fan blade parameters often include blade pitch, blade twist, the shape of the blade when viewed along the axis of rotation of the blade (e.g., blade leading and trailing edge geometries), the cross-sectional shape of the blade in different locations of the blade, and the like.

Although fan performance can often be improved by changing the values of one or more of the fan blade parameters mentioned above, other parameters can also significantly affect fan performance. For example, the size and position of the motor driving the fan can impact fan performance. As another example, fan performance can often be altered by changing the position of the fan with respect to the surrounding environment. Despite the tools available to fan designers, many fan blades and fan blade assemblies continue to have significant performance deficiencies. These deficiencies are often the result of poor selection of fan blade shape and position.

An example of a typical fan application is shown in FIGS. 1 and 2. In this application, a fan 1 is mounted to and driven by a motor 2 in a conventional manner. The fan 1 and motor 2 are received within a condensing unit 3 used to cool fluid passed through the condensing conduit (e.g., condensing coil 9). The condensing unit 3 can be used, for example, in a central air system for cooling a building of any type. Condensing units often use forced convection to remove heat from a refrigerant to prepare the refrigerant for expansion, and can include a long, spiral heat exchanger coil 9 generally shaped like a cylinder. In such cases, the fan 1 can be located within the condensing unit 3 to draw air through the heat exchanger coil 9, which contains the refrigerant. A compressor is usually located within or is coupled to the condensing unit 3 to pump the refrigerant through the heat exchanger coil 9.

In many condensing unit applications, the motor 2 driving the fan 1 is mounted to a bracket 4 proximate a discharge outlet of the condensing unit 3 such that a shaft 5 of the motor 2 (to which the fan 1 is coupled) is pointing into the condensing unit 3. Depending at least in part upon the mounting construction of the motor 2, the bracket 4 can be slightly larger than the motor 2. This relationship can restrict the flow of air toward the center of the fan 1, and can thereby reduce fan performance and create a pocket of “dead air” around the outer surface of the motor 2. The pocket of dead air inhibits heat transfer from the motor 2, thereby further decreasing fan performance by decreasing the motor's efficiency. Flow restrictions and dead air pockets can also be generated by other elements located adjacent the motor 2.

Another design issue arising in many fan applications relates to the position of the fan and motor with respect to the surrounding environment. By way of example only, conventional fan and motor assemblies in condensing unit applications (referring again to FIGS. 1 and 2) are often positioned within the condensing unit 3 such that the fan 1 is located well below the top-most windings of the condensing coil 9. This is often due at least in part to a relatively large axial depth of the motor and fan assembly. In some cases, the fan 1 extends into the condensing unit 3 a distance between about 0.4 and 0.5 times the fan diameter. The relatively large axial depth of the motor and fan assembly can result in a relatively deep position of the fan 1 within the condensing unit 3. Such positioning of the fan 1 typically discourages air from flowing in an effective manner past the top-most windings of the condensing coil 9. Thus, the cooling potential of the top-most windings of the condensing coil 9 is not realized, coil surface area is wasted, and the overall efficiency of the condensing unit 3 suffers. To offset this loss in efficiency, a more powerful motor 2 is often required to increase the speed of the cooling airflow generated by the fan 1.

### SUMMARY OF THE INVENTION

In some embodiments of the present invention, a fan for connection to a motor having an end, an output shaft rotatable about an axis of rotation, and at least one side axially extending from the end of the motor is provided, and comprises a fan blade shaped to extend axially and radially from the axis of rotation when the fan is installed on the output shaft of the motor, the fan blade comprising a radially outermost edge; a radius defined by a circle traced by the radially outermost edge of the fan blade as the fan blade is rotated about the axis of rotation; and an inner annular portion extending axially past the end of the motor to a location beside the motor, a part of the inner annular portion spaced from the axially extending side by a gap no more than about 0.16 times a largest radial dimension of the motor at an axial location shared by the part of the inner annular portion, wherein an angle of at least about zero degrees and no greater than about 40 degrees is defined between a first straight line parallel to the axis of rotation and a second straight line passing through a farthest axially downstream point on a trailing edge of the fan blade, tangent to a surface of the fan blade at the point, and tangent to a cylinder coincident with the axis of rotation and in which the point lies.

Some embodiments of the present invention provide a fan for connection to a motor having an end, wherein the fan comprises a fan blade adapted to be coupled to the motor, rotatable about an axis of rotation, and extending radially and axially from the axis of rotation when coupled to the motor, the fan blade comprising a peripheral edge comprising a radially outermost edge; a leading edge; and a trailing edge; at least part of the peripheral edge extending axially past the end of the motor to an axial location beside the motor, wherein the at least part of the peripheral edge is separated from the motor at the axial location by a gap no greater than about 0.16 times a largest radial dimension of the motor at the axial location; a radius defined by a circle traced by the radially outermost edge of the fan blade as the fan blade is rotated about the axis of rotation; a first point on the leading edge at a tip of the fan blade; and a second point on the trailing edge at a tip of the fan blade; wherein a first angle of at least about 12 degrees and no greater than about 32 degrees is defined between a plane substantially orthogonal to the axis of rotation and a first straight line extending through the first and second points; and wherein a second angle of at least about zero degrees and no greater than about 40 degrees is defined between a second straight line parallel to the axis of rotation and a third straight line passing through a third point at a radially innermost farthest axially downstream point on the fan blade, tangent to a surface of the fan blade at the third point, and tangent to a cylinder coincident with the axis of rotation and in which the third point lies.

In some embodiments, a fan assembly for connection to a motor having opposite ends is provided, and comprises a fan blade adapted to be coupled to the motor for rotation about an axis of rotation, the fan blade comprising a leading edge; and a trailing edge; at least a portion of the trailing edge located an axial distance from at least a portion of the leading edge; wherein rotation of the fan blade in an installed position on the motor defines an annular volume through which the fan blade passes, the annular volume having a radius and a hollow interior; at least a portion of the motor is received within the hollow interior when the fan is in an installed position on the motor; at least one portion of the annular volume is located between the opposite ends of the motor, and is separated from the motor at an axial location by a gap no more than about 0.16 times a largest radial dimension of the motor at the axial location; and an angle of at least about zero degrees and no greater than about 40 degrees is defined between a first straight line parallel to the axis of rotation and a second straight line passing through a farthest axially downstream point on the trailing edge of the fan blade, tangent to a surface of the fan blade at the point, and tangent to a cylinder coincident with the axis of rotation and in which the point lies.

Further objects and advantages of the present invention, together with the organization and manner of operation thereof, will become apparent from the following detailed description of the invention when taken in conjunction with the accompanying drawings, wherein like elements have like numerals throughout the drawings.

### BRIEF DESCRIPTION OF THE DRAWINGS

The present invention is further described with reference to the accompanying drawings, which show an embodiment of the present invention. However, it should be noted that the invention as disclosed in the accompanying drawings is illustrated by way of example only. The various elements and combinations of elements described below and illustrated in the drawings can be arranged and organized differently to result in constructions which are still within the spirit and scope of the present invention.

FIG. 1 is a top view of a conventional fan and motor installed within a condensing unit;

FIG. 2 is a partially sectioned side view of the condensing unit, fan, and motor of FIG. 1, taken along lines 2-2 of FIG. 1;

FIG. 3 is a top perspective view of a fan according to an embodiment of the present invention, shown installed on a motor;

FIG. 4 is a side view of the fan and motor assembly of FIG. 3, showing a side of a fan blade and shown with two other fan blades removed;

FIG. 5 is another side view of the fan and motor assembly of FIG. 3, showing an end of the fan blade and shown with two other fan blades removed;

FIG. 5a is a perspective view of the fan and motor assembly of FIG. 3;

FIG. 6 is a top view of the fan and motor assembly of FIG. 3, shown installed within a condensing unit;

FIG. 7 is a partially sectioned side view of the condensing unit, fan, and motor of FIG. 6, taken along lines 7-7 of FIG. 6;

FIG. 8 is a table in which computer-modeled performance data of a number of different fan and motor assemblies are presented for comparison;

FIG. 9 is a perspective view of a conventional fan and motor assembly, showing a computer-modeled temperature distribution of the motor during operation of the fan and motor assembly;

FIG. 10 is a partial elevational view of the conventional fan and motor assembly illustrated in FIG. 9, showing a computer-modeled flow distribution generated by operation of the fan and motor assembly;

FIG. 11 is a perspective view of a fan and motor assembly according to an embodiment of the present invention, showing a computer-modeled temperature distribution of the motor during operation of the fan and motor assembly;

FIG. 12 is a partial elevational view of the fan and motor assembly illustrated in FIG. 11, showing a computer-modeled flow distribution generated by operation of the fan and motor assembly;

FIGS. 13-18 are perspective and elevational views of modified versions of the fan and motor assembly illustrated in FIGS. 11 and 12, in which a larger gap exists between the motor and the roots of the fan blades, and in which are shown computer modeled motor temperature and airflow distributions of the fan and motor assembly during operation; and

FIGS. 19-24 are perspective and elevational views of modified versions of the fan and motor assembly illustrated in FIGS. 11 and 12, in which the fan blades of each modified fan and motor assembly have larger trailing edge discharge angles, and in which are shown computer modeled motor temperature and airflow distributions of the fan and motor assembly during operation.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising” or “having” and variations thereof herein is meant to encompass the items listed thereafter and equivalents thereof as well as additional items. The terms “mounted,” “connected” and “coupled” are used broadly and encompass both direct and indirect mounting, connecting and coupling. Further, “connected” and “coupled” are not restricted to physical or mechanical connections or couplings. In addition, terms such as “first”, “second,” and “third” are used herein and in the appended claims for purposes of description and are not intended to indicate or imply relative importance or significance.

Various fan and fan blade parameters are referenced herein and in the appended claims. In those cases where the measurement of such parameters is dependent upon the orientation of the fan blades being described or claimed, the parameters are described with reference to the fan blades viewed along the axis of rotation of the fan with no blade twist (described in greater detail below).

Further aspects of the present invention, together with the organization and manner of operation thereof, will become apparent from the following detailed description of the invention when taken in conjunction with the accompanying drawings, wherein like elements have like numerals throughout the drawings.

### DETAILED DESCRIPTION

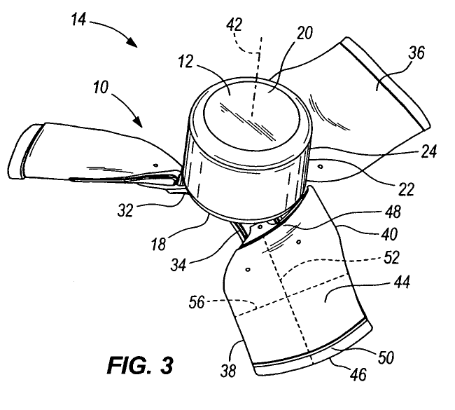

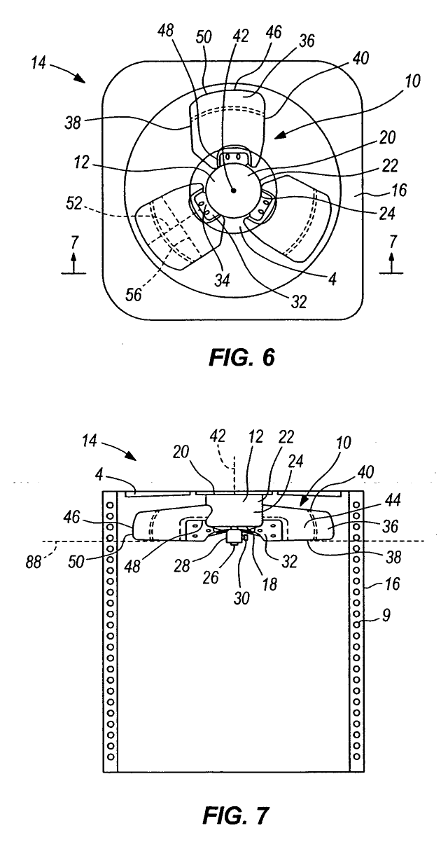

A fan according to an embodiment of the present invention is illustrated in FIGS. 3-7, and is indicated generally at 10. The fan 10 is shown coupled to a motor 12. Together, the motor and fan assembly 14 is illustrated in FIGS. 6 and 7 in an installed position in a condensing unit 16 (e.g., of an air conditioning or other cooling system, not shown).

The fan 10 and motor 12 illustrated in FIGS. 3-7 have respective diameters of about 24 inches and 6 inches, respectively. However, the fan 10 and/or motor 12 can be larger or smaller in other embodiments. For example, in some embodiments, the fan 12 is at least 16 inches in diameter and is no greater than 30 inches in diameter, although smaller and larger fans are possible. Also, in some embodiments, the motor 12 has a largest radial dimension of between about 3 and 7 inches, although smaller and larger motors are possible.

As described in greater detail below, the fan 10 illustrated in FIGS. 3-7 has a number of features. However, it should be noted that fans according to other embodiments of the present invention have fewer than all of these features. Accordingly, the fan 10 illustrated in FIGS. 3-7 and described below is presented by way of example only in order to illustrate various features of the present invention, and does not indicate or imply that all such features are required in other embodiments.

In addition, the application of the fan 10 in a condensing unit 16 as described below is presented by way of example only, and is not intended to indicate or imply that the fan 10 is limited to any particular application or applications. The fan 10 can be used in any equipment or environment in which air (or other gases, vapors, fumes, or other fluids or combinations of fluids) is to be moved.

The motor 12 can be any type of prime mover desired. In some embodiments, the motor 12 can be a hydraulic or electric motor. By way of example only, the motor 12 illustrated in FIGS. 3-7 is a NEMA (National Electrical Manufacturer's Association) 42 or 48 Frame permanent split capacitor motor. However, any other type of electric motor having any size and power can be used. The motor 12 illustrated in FIGS. 3-7 is generally cylindrical in shape and has opposite ends 18, 20. In some embodiments, the motor 12 has a housing 22 with a cylindrical sidewall 24 joining the ends 18, 20 of the motor 12. In other embodiments, the motor 12 (or other prime mover) can have other shapes, such as a block shape, an irregular shape, and the like.

The motor 12 illustrated in FIGS. 3-7 has an output shaft 26 to which the fan 10 can be permanently or releasably coupled in any manner. For example, the fan 10 can be coupled to the output shaft 26 by a hub 28. The hub 28 can be splined or threaded, can have one or more setscrews 30 as shown in the illustrated embodiment of FIGS. 3-7, can be secured to the output shaft 26 by a compression or interference fit, by a keyed connection, or in any other manner. The hub 28 can take a number of different forms, such as a collar or bushing, an annular boss or wall of the fan 10 (e.g., a boss or wall surrounding an aperture of a spider 32, described in greater detail below).

In other embodiments, the fan 10 can be permanently or releasably coupled to the motor 12 in any other manner desired, some of which do not utilize a hub 28 as described above. Such alternative manners of connection are conventional in nature and are not therefore described further herein.

The fan 10 illustrated in FIGS. 3-7 comprises a spider 32 having multiple spider arms 34, each of which has a fan blade 36 coupled thereto. The fan 10 can have any number of fan blades 36 (e.g., three in the illustrated embodiment). Accordingly, the spider 32 can have any number of spider arms 34 corresponding to the number of fan blades 36. The spider arms 34 and fan blades 36 can be equally spaced as best shown in FIG. 6, although this is not required in all embodiments of the present invention. Also, each of the spider arms 34 can be coupled to a respective fan blade 36 in any manner, such as by rivets, screws, welding or brazing, adhesive or cohesive bonding material, inter-engaging elements on the spider 32 and fan blades 36, and the like. In some embodiments, the spider arms 34 are integral with the fan blades 36.

Each of the fan blades 36 has a leading edge 38 and a trailing edge 40 with respect to the direction of rotation of the fan 10. As the fan 10 rotates about an axis of rotation 42 (defined by the output shaft 26 of the motor 12 illustrated in FIGS. 3-7), fluid first moves over the leading edge 38, then across a face 44 of the fan blade 36, and over the trailing edge 40. The leading and trailing edges 38, 40 of the blades 36 illustrated in FIGS. 3-7 are substantially straight (see FIG. 6). In other embodiments, however, the leading and/or trailing edges 38, 40 can be concave, convex, or can have any combination of concave and convex portions.

The fan blades 36 each have a radially outermost edge 46 extending between and joining the leading and trailing edges 38, 40. The radially outermost edge 46 can have a constant or changing radius. Therefore, the radius of the fan 10 can be defined at a radially outermost point of the fan blade 36 or by a radially outermost edge of the fan blade 36, either of which trace a circle upon rotation of the fan blade 36 about the axis of rotation 42.

Each of the fan blades 36 also has a root 48, a tip 50, and a length 52 extending from the root 48 to the tip 50. In the illustrated embodiment of FIGS. 3-7, for example, the root 48 is the area of the fan blade 36 at which the fan blade 36 is coupled to the spider 32. The tip 50 of the fan blade 36 can be defined by the radially outermost edge 46 of the fan blade 36. In some embodiments, the tip 50 is a point on the fan blade 36, whereas in other embodiments, the tip 50 extends along a line. For example, the tip 50 of the fan blade 36 illustrated in FIGS. 3-7 extends along the radially outermost edge 46, which has a substantially constant radius centered about the axis of rotation 42. As another example, the tip 50 of the fan blade 36 can instead be a point at which the radially outermost edge 46 meets the leading edge 38 or trailing edge 40 (e.g., for fan blades 36 having a radially outermost edge 46 with a non-constant radius).

In some embodiments, each fan blade 36 has a substantially constant width 56 along at least a portion of the length 52 of the fan blade 36, wherein the width 56 at any given location along the length 52 of the fan blade 36 is measured as the distance along a straight line between a point on the leading edge 38 and a point on the trailing edge 40 at the same radial distance. For example, the fan blades 36 illustrated in FIGS. 3-7 each have a substantially constant width 56 along a majority of their length 52. In other embodiments, the width 56 of each fan blade 36 can increase or decrease with greater radial distance from the axis of rotation 42, or can increase, decrease, or remain substantially constant in different annular sections of the fan blade 36.

The fan blades 36 according to the present invention utilize one or more design features to achieve a level of performance equal or superior to that of larger and heavier fans. As will now be discussed, these design features include a fan blade 36 shaped to extend to a location beside and within a range of distances of a surface of the motor 12, ranges of blade twist and pitch, ranges of radial and circumferential camber to chord ratios, and ranges of blade trailing edge angles. Whether used alone or in any combination, each of these design features represents a parameter at least partially defining the shape and orientation of the fan blade 36.

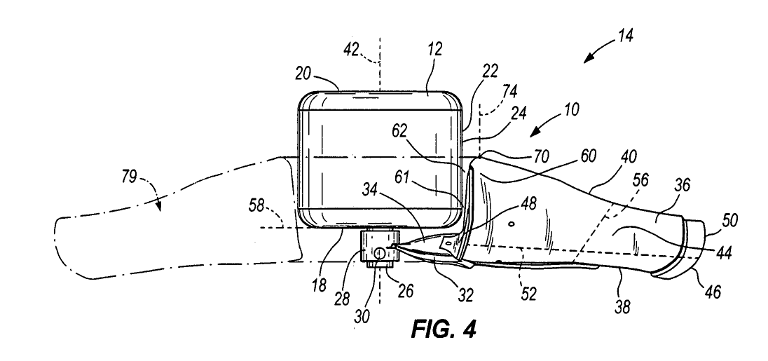

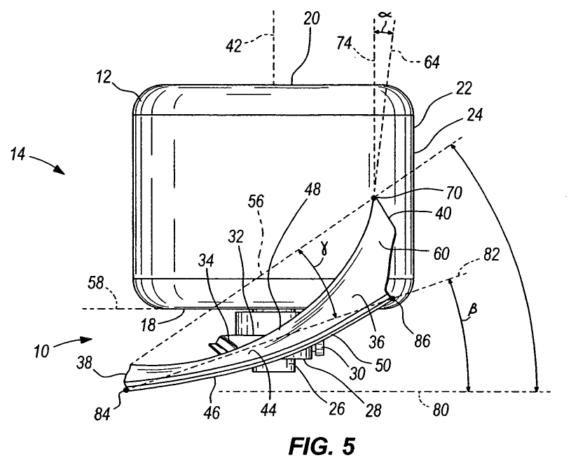

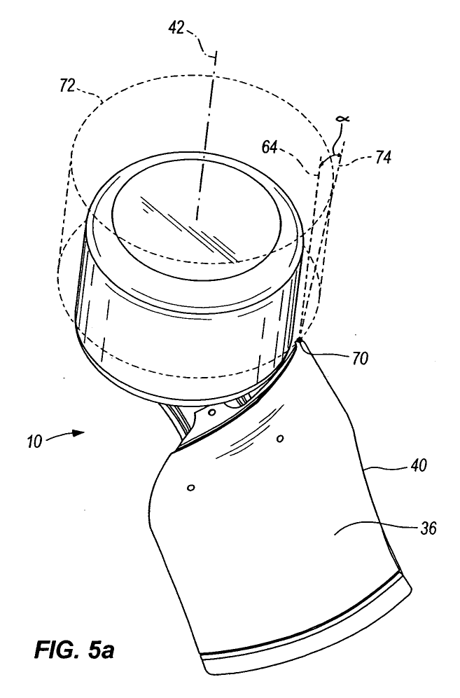

Some embodiments of the present invention have fan blades 36 that are shaped to wrap around the motor 12. With reference to the illustrated embodiment of FIGS. 3-7 for example, a portion of each fan blade 36 extends in an axial direction toward the motor 12 as the fan blade 36 extends radially away from the axis of rotation 42. With particular reference to FIGS. 4 and 5, the fan blades 36 each extend past an end 18 of the motor 12 (see plane 58 shown in FIGS. 4 and 5) to a location beside the motor 12. Accordingly, a portion 60 of each fan blade 36 is located between the ends 18, 20 of the motor 12 and is spaced a distance from the motor 12 (e.g., spaced from the sidewall 24 of the motor housing 22). In some embodiments, the portion 60 is an inner annular portion of the fan blade 36.

Rotation of the fan blade 36 defines an annular volume 79 (see FIG. 4) through which the fan blade 36 passes. In some embodiments, the annular volume 79 has a radius defining a radius of the fan 10. Also, in some embodiments the annular volume 79 has a hollow inner portion in which at least part of the motor 12 is received. Therefore, in such embodiments at least a portion of the annular volume is located between the ends of the motor 12.

In some embodiments, a gap 61 (see FIG. 4) exists between the motor 12 and the portion 60 of the fan blade 36 between the ends 18, 20 of the motor 12 (e.g., between the motor 12 and the portion of the annular volume between the ends 18, 20 of the motor 12). This gap 61 can be substantially constant or can vary at different axial positions alongside the motor 12, and has one or more locations at which the gap 61 is narrowest. The inventors have discovered that in such locations, a maximum gap 62 (see FIG. 4) can significantly affect fan performance in some embodiments.

In some cases, the maximum gap 62 is dependent at least in part upon the size of the motor 12. A larger or smaller maximum gap 62 is often acceptable in applications where a larger or smaller motor 12 and fan 10 are used, respectively. Depending at least in part upon the shape of the motor 12, the gap 61 between the portion 60 of the fan blade 36 (or the annular volume) and the motor 12 at a common location along the axis of rotation 42 can change at different circumferential locations about the motor. For example, in those embodiments in which the motor 12 has polygonal or irregular cross-sectional shape generated by a plane orthogonal to the axis of rotation 42, the gap 61 between the portion 60 of the fan blade 36 and an adjacent portion of the motor 12 can vary at different circumferential positions about the motor 12. In such cases, the inventors have discovered that a maximum gap 62 between the motor 12 and a largest radial dimension of the motor 12 at the same axial location can significantly affect fan performance.

The maximum gap 62 can be expressed as a fraction of the largest radial dimension of the motor 12 at a common axial location. In some embodiments, the maximum gap 62 between the fan blade 36 (or annular volume generated by rotation of the fan blade 36) and the largest radial dimension of the motor 12 (e.g., the radius of the motor 12, in some embodiments) at the same axial location is no more than about 0.16 times the largest radial dimension of the motor 12 at the axial location. In other embodiments, this maximum gap 62 is no more than about 0.09 times the largest radial dimension of the motor 12 at the same axial location. In still other embodiments, this maximum gap 62 is no more than about 0.03 times the largest radial dimension of the motor at the same axial location.

Another parameter that can affect fan performance is the orientation of the trailing edge 40 of each fan blade 36. With continued reference to FIGS. 3-7, the trailing edge 40 of each fan blade 36 is shaped to extend axially beside the motor 12 as the fan blade 36 extends radially from the axis of rotation 42. Accordingly, surfaces of the fan blade 36 adjacent the trailing edge 40 deflect air (or other fluid moved by the fan 10) toward an axial direction as the air moves across the face 44 of the fan blade 36. Although the axial direction need not necessarily be parallel to the axis of rotation 42, the direction of air leaving the trailing edge 40 of the fan blade 36 has an increased axial component.

The shape of the trailing edge 40 described above can be defined in part by an acute angle (hereinafter called a “discharge angle α”) between a line 74 parallel to the axis of rotation 42 and a straight line 64 tangent to the fan blade 36 at a point 70 on the trailing edge 40 of the fan blade 36. With reference to the fan 10 illustrated in FIGS. 3-7, and with particular reference to FIG. 5a, the point 70 is located on the trailing edge 40 of the fan blade 36 at an axial end of the fan blade 36 (i.e., at a farthest downstream location of the fan blade 36). In some embodiments, the fan blade 36 has two or more points or a line at a farthest downstream location of the fan blade 36. In such embodiments, the point 70 is the radially innermost point of such points or of such a line.

The orientation of the line 64 is also defined by the relationship of the straight line 64 to a cylinder 72 parallel to and centered about the axis of rotation 42. Specifically, the line 64 tangent to the fan blade 36 at a point on the trailing edge 40 (as described above) is also tangent to the cylinder 72. In some embodiments, the discharge angle α between this line 64 and the line 74 parallel to the axis of rotation 42 is at least about zero degrees and is no greater than about 40 degrees. In other embodiments, the discharge angle α is at least about zero degrees and is no greater than about 20 degrees. In still other embodiments, the discharge angle α is at least about zero degrees and is no greater than about 8 degrees.

With reference again to FIGS. 3-7, each fan blade 36 in the illustrated embodiment is bowed between the leading and trailing edges 38, 40. Accordingly, each fan blade 36 has a circumferential camber to chord ratio greater than zero. With respect to any cross-sectional view of the fan blade 36 taken along an arc of constant radius and centered about the axis of rotation 42, the chord is the length of the arc between the leading and trailing edges 38, 40, and the camber is the deepest dimension of the fan blade 36 at the same radius. A large circumferential camber-to-chord ratio therefore indicates a deeper blade form compared to a smaller circumferential camber-to-chord ratio.

The circumferential camber-to-chord ratio of each fan blade 36 (measured as just described) can be substantially constant or can change at different radial distances from the axis of rotation 42. In the illustrated embodiment for example, the circumferential camber-to-chord ratio of each fan blade 36 grows along the length of the fan blade 36 in a direction from the tip 50 toward the root 48. In some embodiments, the circumferential camber-to-chord ratio of the fan blade 36 drops by at least about 20% along the length of the fan blade 36. In other embodiments, the circumferential camber-to-chord ratio of the fan blade 36 drops by at least about 30% along the length of the fan blade 36. In still other embodiments, a drop in circumferential camber-to-chord ratio of at least about 40% along the length of the fan blade 36 is used.

The inventors have also discovered that certain sizes of circumferential camber-to-chord ratios of the blade 36 at various radial distances from the axis of rotation 42 can also provide good fan performance. In some embodiments, the circumferential camber-to-chord ratio of the fan blade 36 at 0.2 times the radius of the fan 10 is at least about 0.8, and is no greater than about 0.18. In other embodiments, the circumferential camber-to-chord ratio of the fan blade 36 at 0.5 times the radius of the fan 10 is at least about 0.07, and is no greater than about 0.14. In still other embodiments, the circumferential camber-to-chord ratio of the fan blade 36 at 0.98 times the radius of the fan 10 is at least about 0.02, and is no greater than about 0.06 in order to produce good performance results.

Another parameter that can affect fan performance is the camber-to-chord ratio of the fan blade 36 along a radially-extending cross-section of the fan blade 36. This radial camber-to-chord ratio can be substantially constant across the width of the fan blade 36 (i.e., in different cross sections extending through the fan blade 36 at different circumferential positions between the leading and trailing edges 38, 40). However, in other embodiments, this radial camber-to-chord ratio can change across the width of the fan blade 36.

With continued reference to the illustrated embodiment of FIGS. 3-7, some embodiments of the fan 10 have fan blades 36 pitched toward the direction of rotation (i.e., defining an angle of attack or pitch of each fan blade 36). In some embodiments, the pitch of each fan blade 36 is measured as an angle β between a plane 80 (see FIG. 5) orthogonal to the axis of rotation 42 and a straight line 82 extending through a point 84 on the leading edge 38 at the tip 50 of the fan blade 36 and a point 86 on the trailing edge 40 at the tip of the fan blade 36. In some embodiments, the angle β measured as just described is at least about 12 degrees and is no greater than about 32 degrees. In other embodiments, this angle β is at least about 12 degrees and is no greater than about 24 degrees. In still other embodiments, this angle β is at least about 12 degrees and is no greater than about 18 degrees.

With continued reference to FIG. 5, each fan blade 36 can have a shape that is twisted along the length of the fan blade 36. The inventors have discovered that blade twist amounts selected from certain blade twist ranges can produce good performance results. The amount of twist of each fan blade 36 can be calculated as the difference between the pitch of the fan blade 36 at the blade tip 50 and the pitch of the fan blade 36 at the blade root 48. In some embodiments, the blade twist angle γ is at least about 10 and is no greater than about 30. In other embodiments, the blade twist angle γ is at least about 10 and is no greater than about 24. In still other embodiments, a blade twist angle γ of at least about 10 and no greater than about 16 is used.

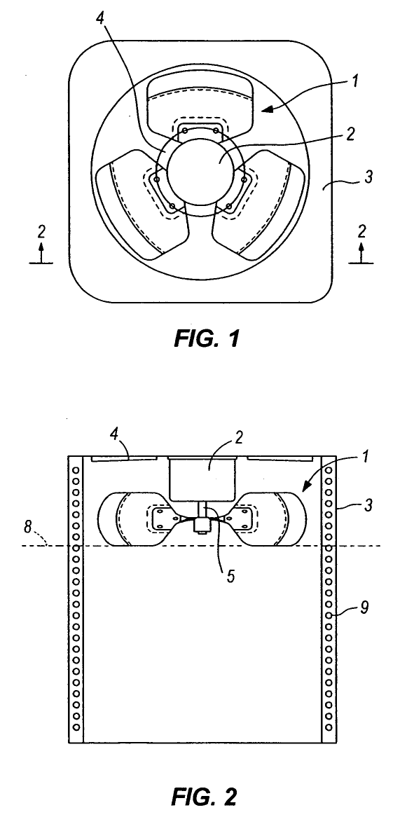

As mentioned above, an example of an application for the motor and fan assembly 14 is illustrated in FIGS. 6 and 7, which illustrates the motor and fan assembly 14 in an installed position in a condensing unit 16 similar to the condensing unit illustrated in FIGS. 1 and 2. In this application, the motor 12 can be mounted to the same bracket 4 used to mount the motor 2 described above, or to any other bracket or mounting structure desired.

In some embodiments, the fan blades 36 that are shaped to wrap around the motor 12 and that have one or more of the fan blade parameters described above can have a significantly increased effective length (i.e., that portion of the fan blade 36 performing the large majority work in moving fluid by rotation of the fan 10). The additional effective blade length can increase the efficiency of the fan 10 by providing an increased airflow for the amount of power input to the motor 12.

The portion 60 of the fan 10 that wraps around the motor 12 and that is located between the ends 18, 20 of the motor 12 can also draw cooling air over the motor housing 22, thus helping to dissipate heat generated by the motor 12. As a result, “dead air” commonly associated with many conventional fan and motor assemblies when mounted in typical condensing units 16 can be replaced with the flow of cooling air over the motor housing 22. This can also contribute to an effective increase in the efficiency of the fan 10, since many motors 12 operate more efficiently when cooled, thus decreasing the power input requirement to the motor 12.

With reference to FIGS. 2 and 7, the fan and motor assembly 14 shown in FIG. 7 has a decreased axial depth compared to the conventional fan 1 and motor 2 shown in FIG. 2, and therefore extends a shorter axial distance into the condensing unit 16. The wraparound portion 60 of each of the fan blades 36 (see FIGS. 4 and 5) helps enable the fan 10 to be positioned closer to the motor 12 compared to conventional fan and motor assemblies. As a result, an intake plane 88 of the motor and fan assembly 14 (i.e., a plane upstream of the fan 10 and defining an upstream boundary through which air is drawn into the fan 10) according to the present invention can be significantly higher relative to the condensing unit 16 compared to the intake plane 8 of a conventional fan and motor assembly. In some embodiments, the fan 10 according to the present invention can extend into the condensing unit 16 a distance between about 0.2 and 0.3 times the fan diameter—an axial depth considerably less than comparable conventional fans. Therefore, the intake plane 88 of the fan 10 according to some embodiments of the present invention can be positioned so that fewer windings of the heat exchanger coil 9 are located above the intake plane 88. As a result, more windings of the heat exchanger coil 9 can be effectively cooled, yielding an overall increase in efficiency of the condensing unit 16. To take advantage of this increase in efficiency, a lower-horsepower motor 12 can be used to generate cooling airflow and to yield equivalent or improved cooling to the heat exchanger coil 9.

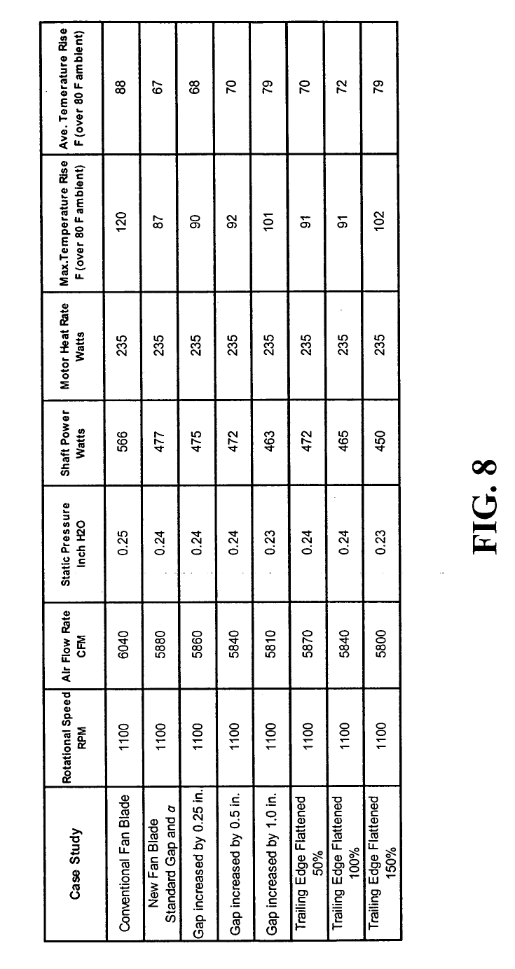

FIG. 8 is a table of computer-generated performance data for several different fan assemblies in a sensitivity analysis of fan blade parameters described above. Each row of the table represents a particular fan assembly including a different fan blade as modeled in a computer analysis. Each column is either an input value or output value for each of the different fan blades modeled. For each fan blade, the rotational speed is held constant at 1100 revolutions per minute (RPM), and the heat given off by the motor 12 is constant at 235 Watts. Data for a conventional fan blade is presented, as well as that of a fan assembly according to an embodiment of the present invention. The conventional fan blade is 24 inches in diameter, and has three blades, a maximum gap 62 of 0.47 inches for a 5.63 inch diameter motor, a discharge angle α of 52 degrees, a pitch β of 31 degrees, and a blade twist angle γ of 0 degrees. The blade according to an embodiment of the present invention (i.e., “New Fan Blade” in FIG. 8) is 24 inches in diameter, and has three blades, a maximum gap 62 of 0.25 inches for a 5.63 inch diameter motor, a discharge angle α of 10.0 degrees, a pitch β of 32 degrees, and a blade twist angle γ of 15 degrees.

As also shown in FIG. 8, the New Fan Blade is also modeled with modified motor-to-fan blade gaps and modified discharge angle (α) values (represented by the last six rows of the table). For each modified fan blade, only the as-noted modified parameter is changed—all other parameters of the fan blade remain the same as the “Standard” New Fan Blade (represented by the data in the second row of the table).

While providing a slightly higher flow rate than the new fan blade, the conventional fan blade requires a driving power of 566 Watts, compared to 477 Watts required to drive the new fan blade. Also, as indicated by the final two columns of the table, the temperatures on the motor are reduced by the replacement of the conventional blade with that of the New Fan Blade according to an embodiment of the present invention.

Rows 3-5 of the table illustrated in FIG. 8 represent various amounts of additional maximum radial gap between the fan blade 36 and the motor 12. All other fan blade parameters were kept the same as the parameters modeled for the Standard New Fan Blade of the second row of the table. Rows 3, 4, and 5 represent respective increases in radial maximum gap of 0.25 inches, 0.5 inches, and 1.0 inches, respectively. While the required shaft power for the fans having the modified radial maximum gaps shows a decrease with increasing maximum gap, this decrease comes at the expense of increased motor temperatures (resulting at least in part from a lower ability of such fans to remove motor heat).

Rows 6-8 of the table represent a modeled increase in the discharge angle α of the fan blades for three modified fans. The changes are made in percentage that the trailing edge is flattened. Rows 6-8 represent discharge angles α of 15.8 degrees, 25.3 degrees, and 36.0 degrees, respectively. Similar to the manipulation of the blade-to-motor gap described above, an increase in discharge angle α results in a reduction in required shaft power and a significant increase in motor temperature.

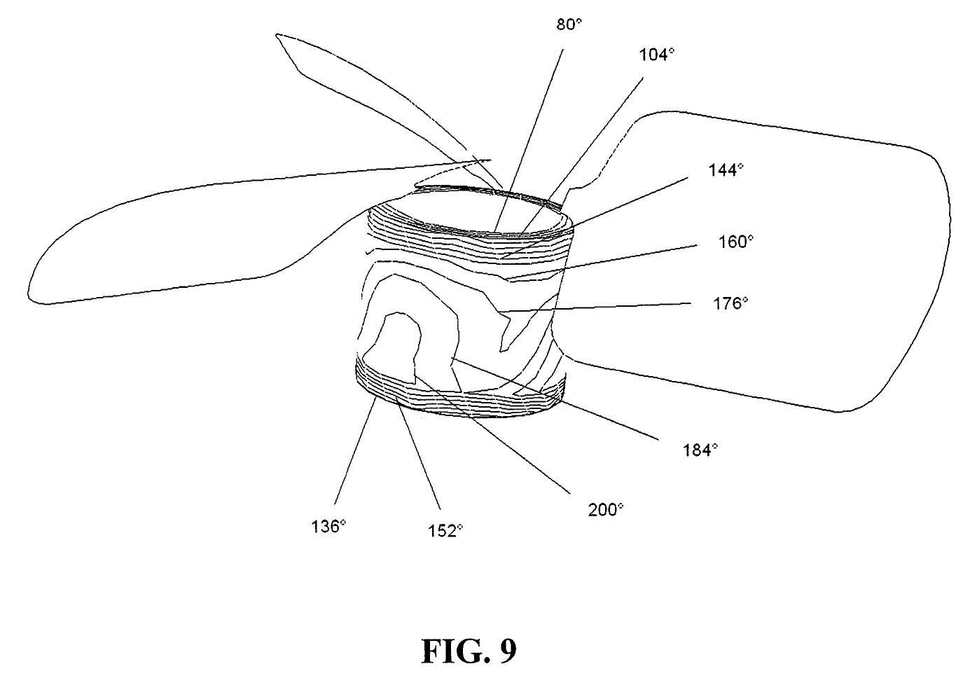

FIG. 9 illustrates a computer-generated temperature profile of a motor driving a fan assembly with the conventional fan blade described above in connection with FIG. 8. This temperature profile is reflected in the table of FIG. 8, which shows an average temperature rise of 88 degrees Fahrenheit and a maximum temperature rise of 120 degrees Fahrenheit (over 80 degrees Fahrenheit ambient).

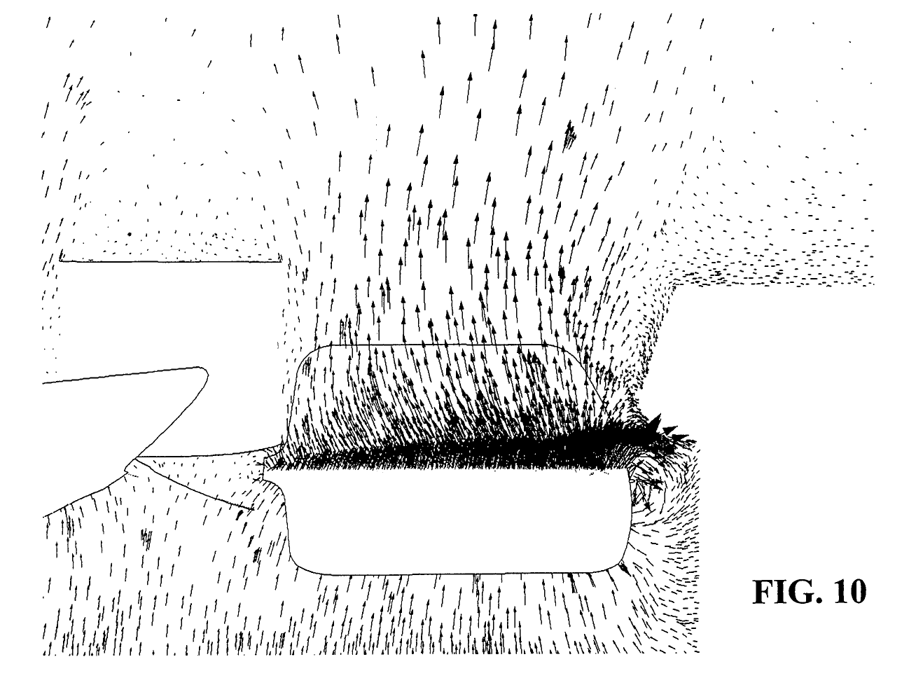

FIG. 10 illustrates a computer-generated flow analysis for the conventional fan blade of FIG. 9. The lengths of the arrows represent local air velocities. As shown, the air velocity at the innermost radius or root of the fan blade is very low compared to that at the outer edge. Although commonplace for conventional fan blades, this represents a significant inefficiency. In particular, airflow is unevenly distributed across the length of the fan blade, leaving a large portion of the blade with reduced air-moving effectiveness.

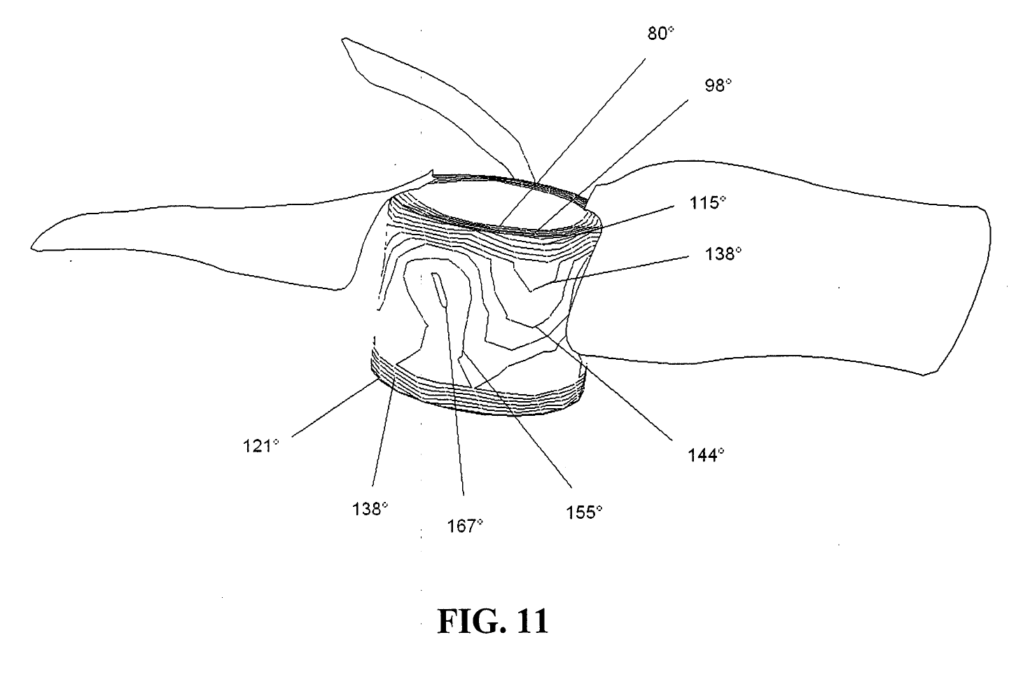

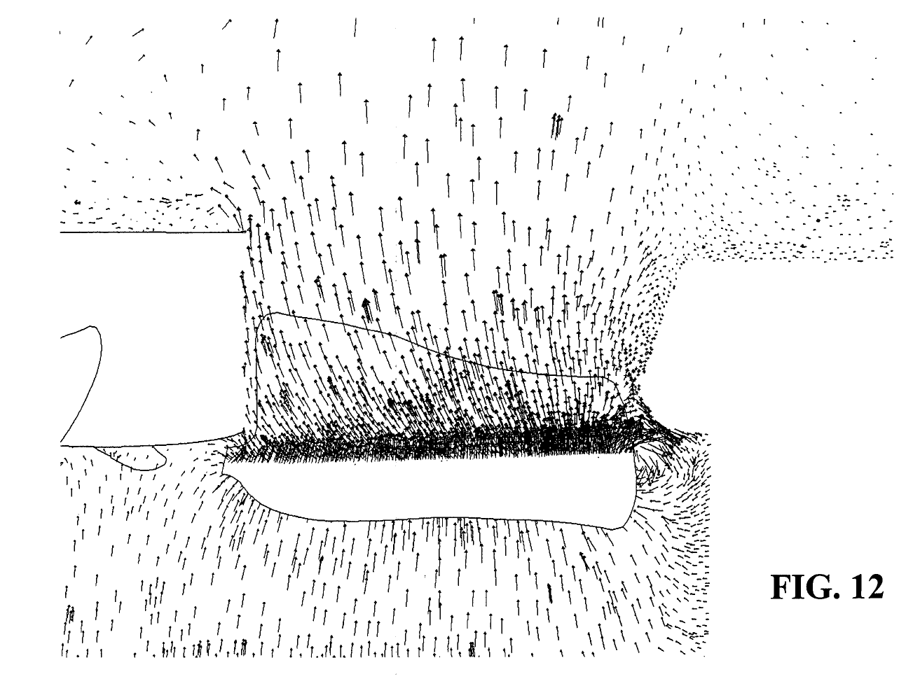

FIGS. 11 and 12 are respectively similar to FIGS. 9 and 10, but represent the temperature and flow distribution profiles for the New Fan Blade of FIG. 8 (described above). FIG. 11 shows a dramatic improvement in the temperature distribution of the motor due to the new fan blade, which cools the motor more than the conventional fan blade. This additional cooling effect occurs simultaneously with a decrease in required shaft power from the conventional fan blade. FIG. 12 also shows a much more balanced flow profile along the length of the fan blade, resulting in a more efficient fan.

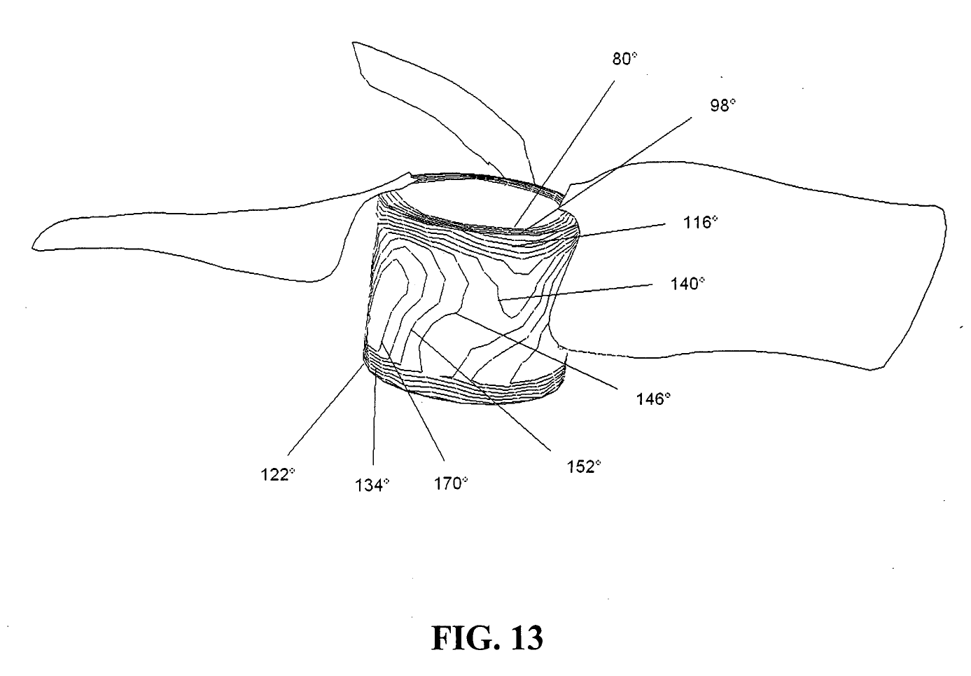

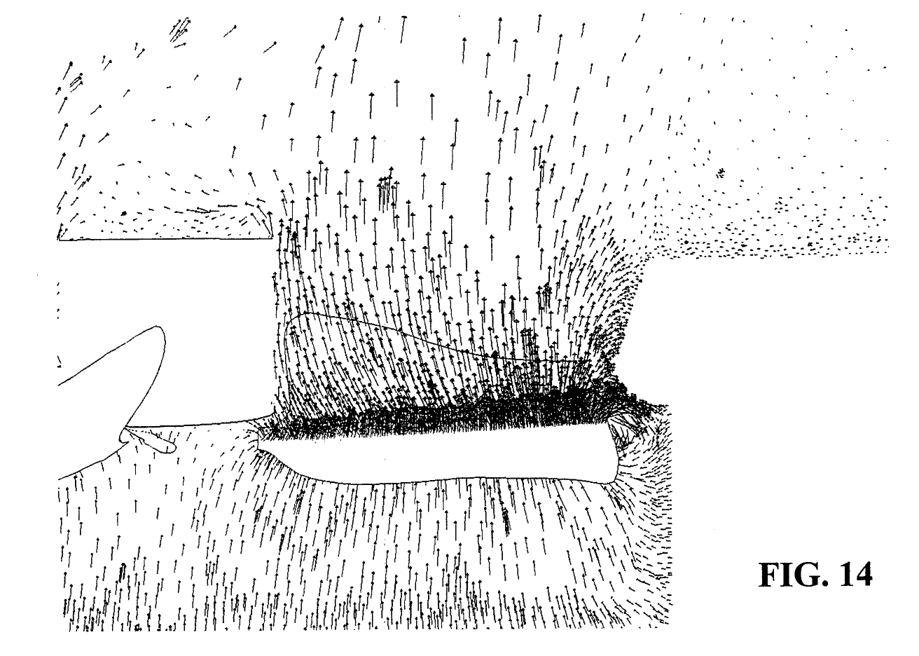

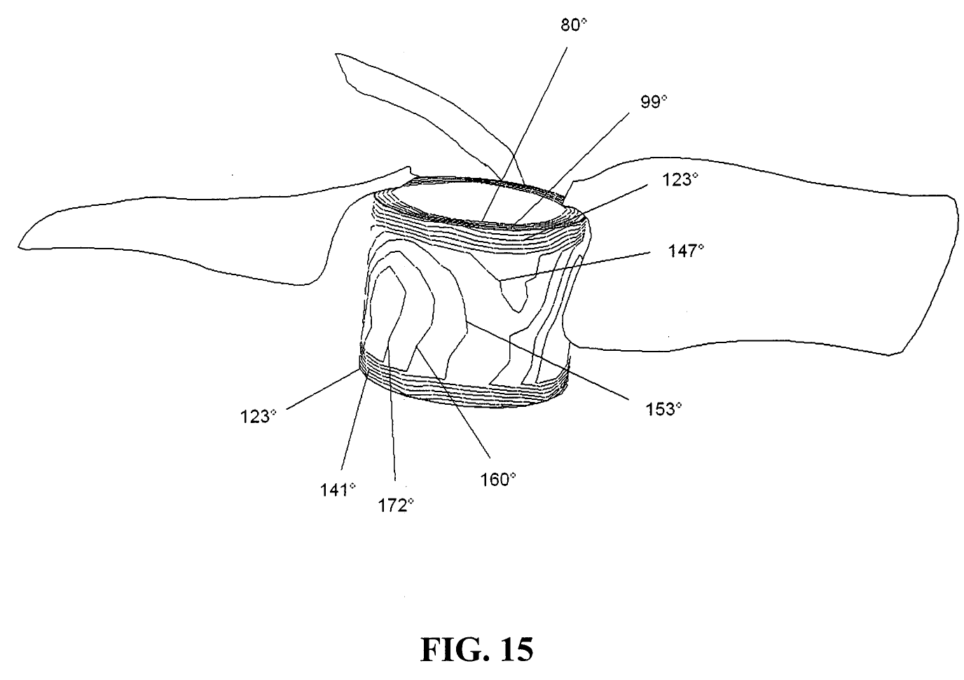

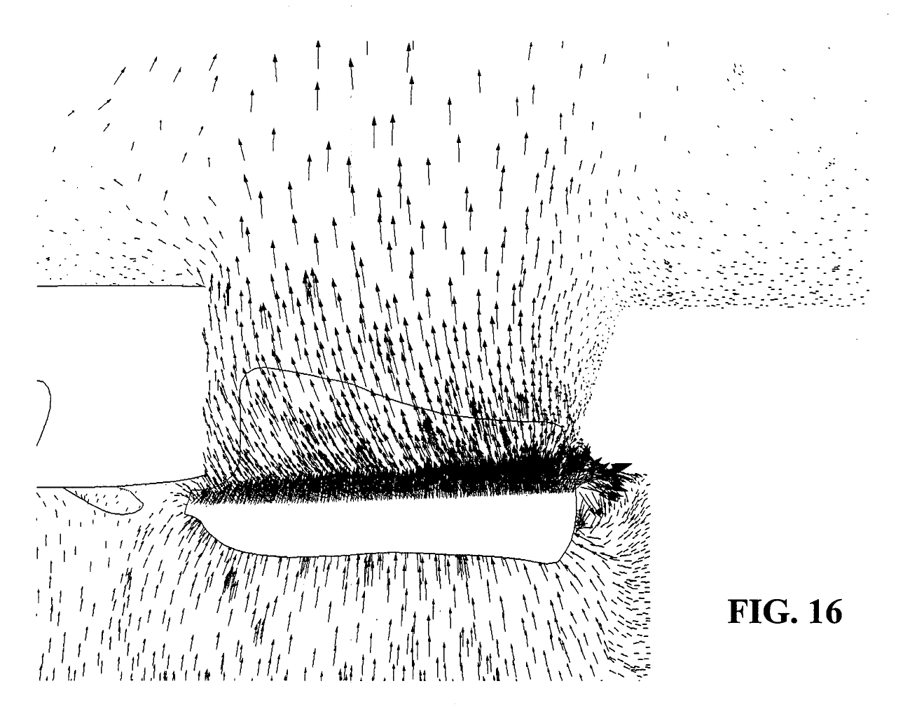

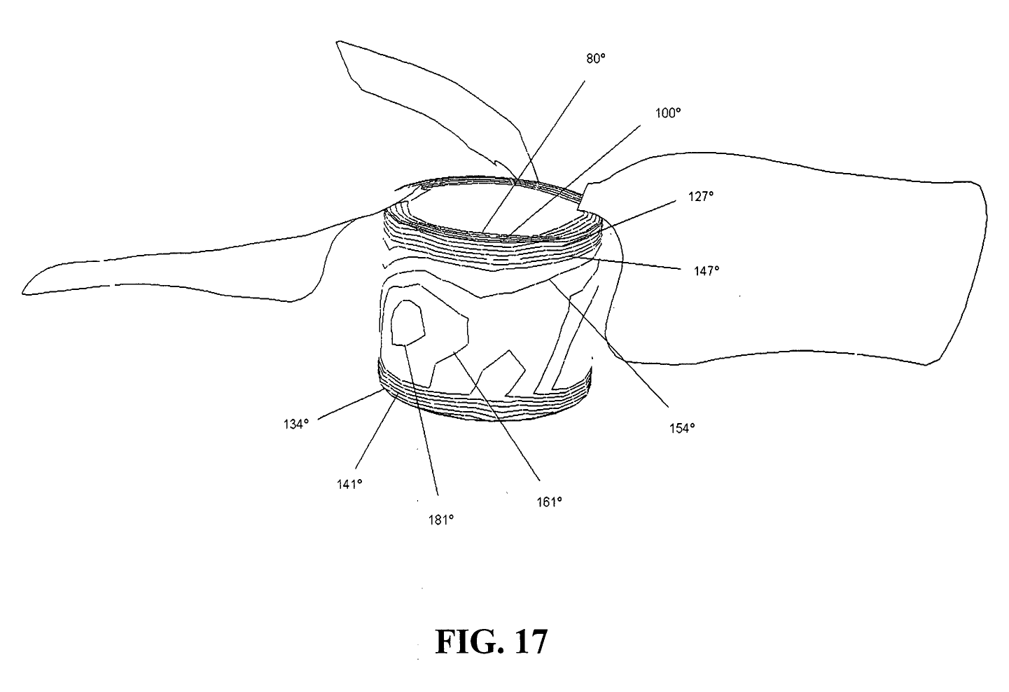

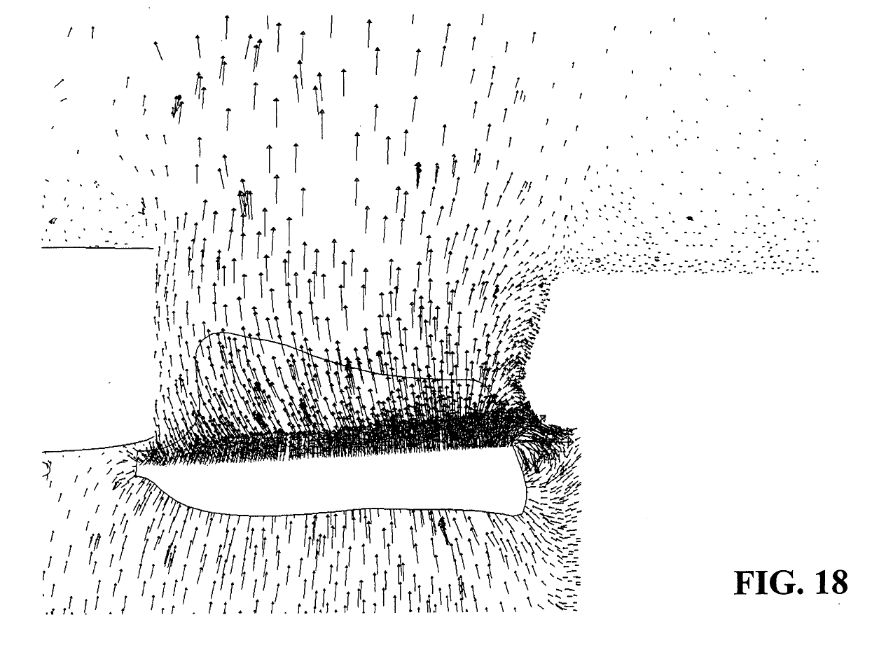

FIGS. 13-18 illustrate computer modeled motor temperature and flow distribution profiles for the modified New Fan Blades in rows 3, 4, and 5 of FIG. 8. As mentioned above, these modified New Fan Blades each have a larger maximum radial gap between the motor and fan blade. FIGS. 13 and 14 illustrate the temperature and flow profiles for a modified New Fan Blade with a maximum radial gap between the motor and fan blade of 0.25 inches more than the standard maximum radial gap (i.e., 0.5 inches total). FIGS. 15 and 16 illustrate the temperature and flow profiles for a modified New Fan Blade with a maximum radial gap between the motor and fan blade of 0.5 inches more than the standard maximum radial gap (i.e., 0.75 inches total). FIGS. 17 and 18 illustrate the temperature and flow profiles for a modified New Fan Blade with a maximum radial gap between the motor and fan blade of 1.0 inch more than the standard maximum radial gap (i.e., 1.25 inches total). Although these three modified New Fan Blades are different in performance from one another, the simulated performance of the fans under all three values of increased maximum radial gap shows marked reduction in shaft power and motor temperature over the conventional fan blade.

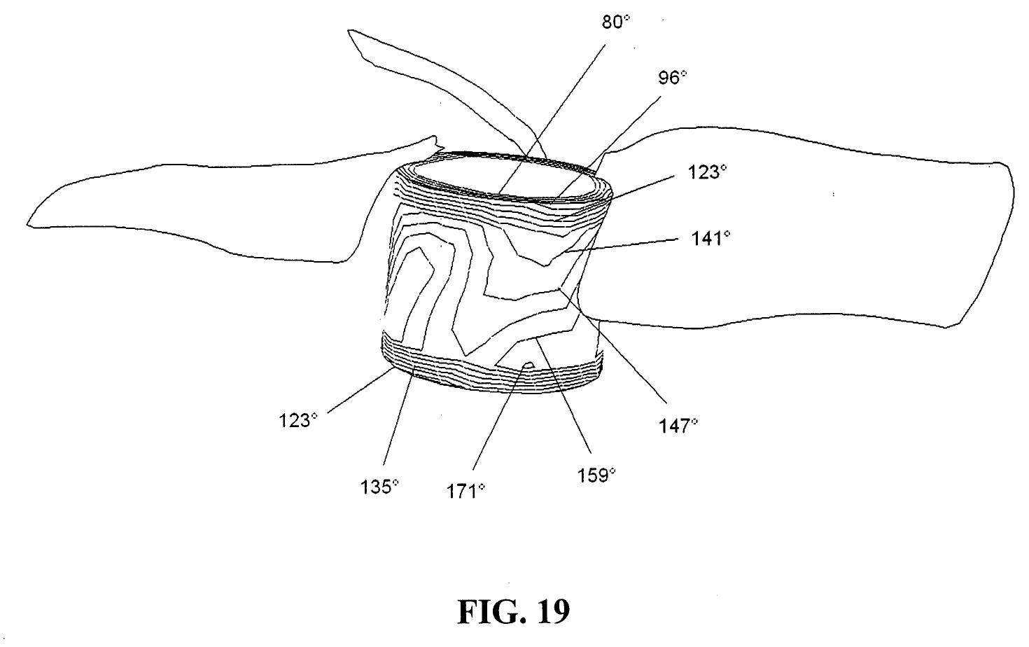

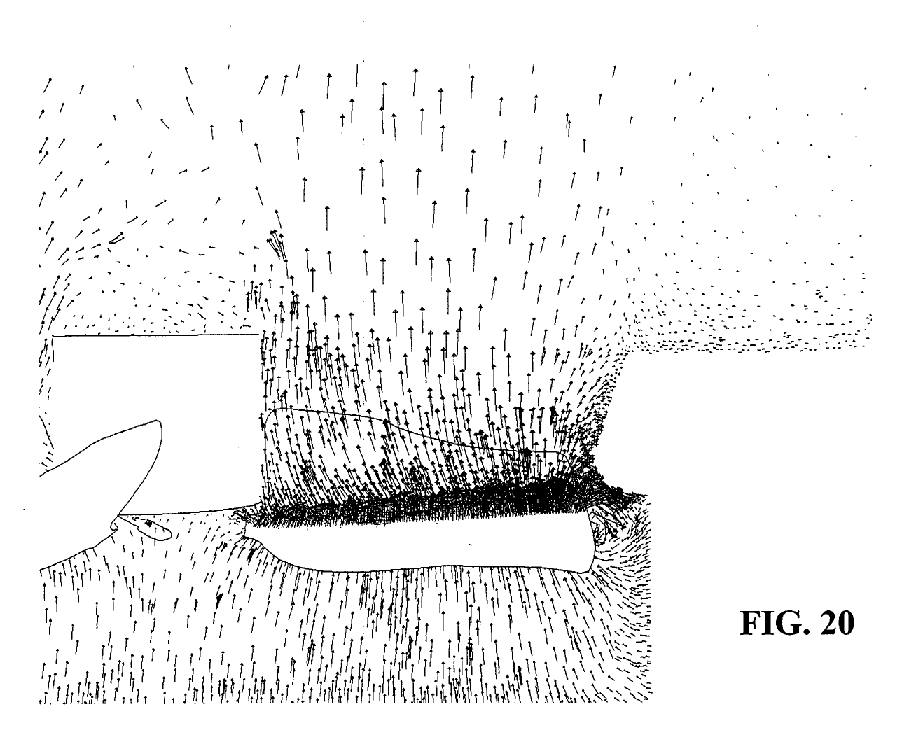

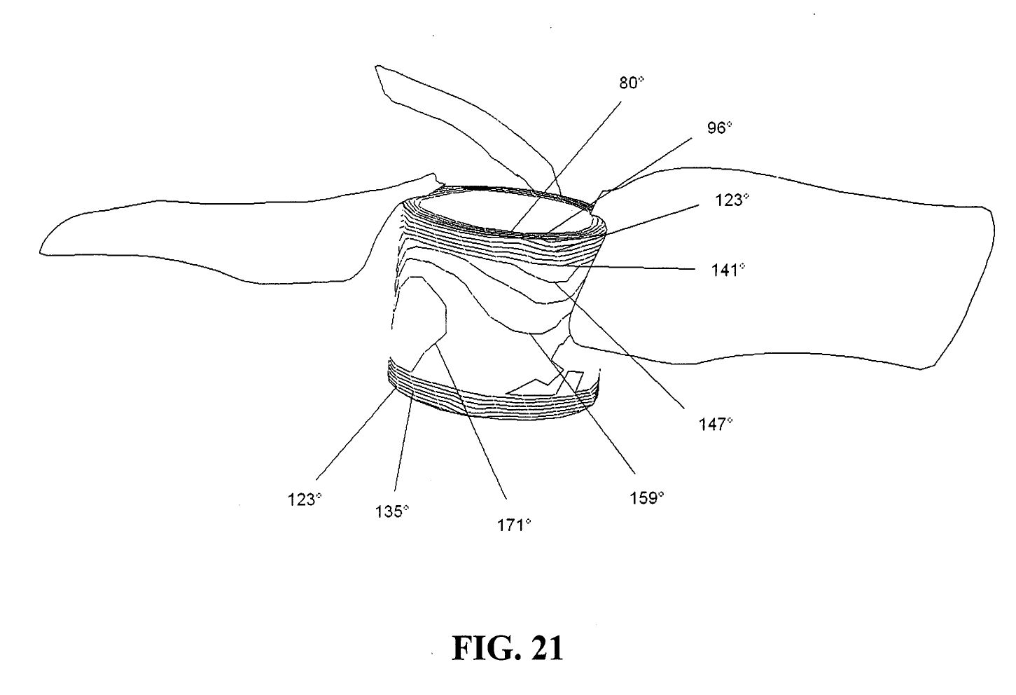

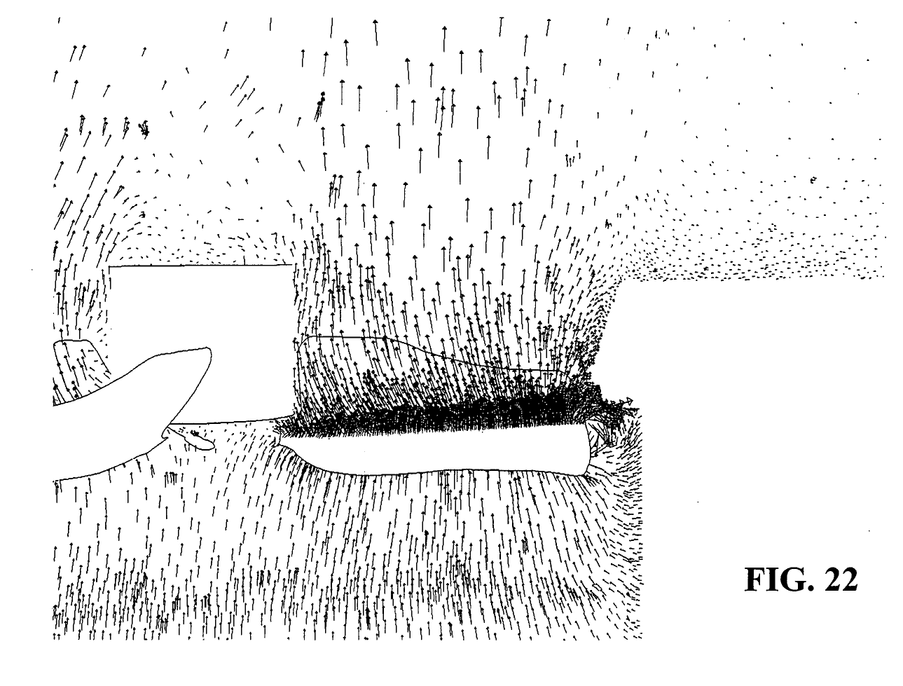

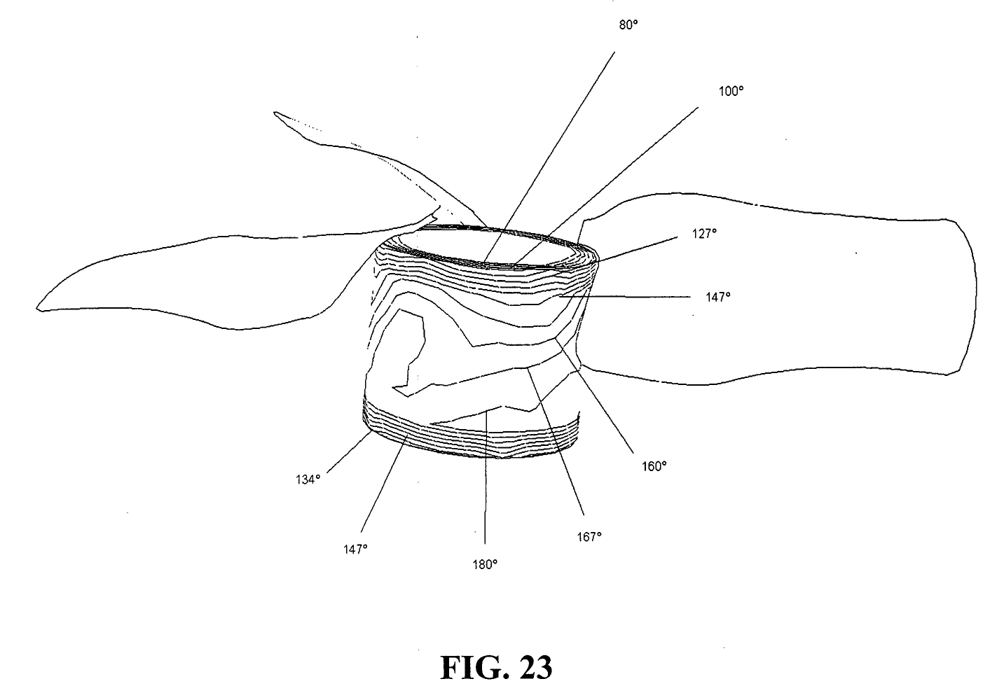

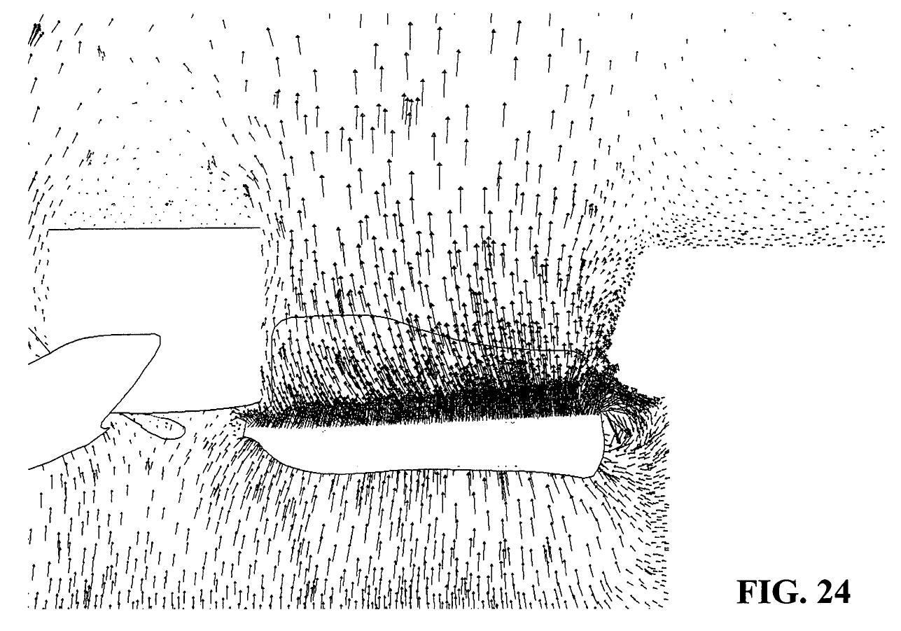

FIGS. 19-24 illustrate computer modeled motor temperature and flow distribution profiles for the modified New Fan Blades in rows 6, 7, and 8 of FIG. 8. As mentioned above, these modified New Fan Blades each have a flattened trailing edge (i.e., increased discharge angle α). FIGS. 19 and 20 illustrate the temperature and flow profiles for a modified New Fan Blade with a discharge angle α of 15.8 degrees. FIGS. 21 and 22 illustrate the temperature and flow profiles for a modified New Fan Blade with a discharge angle α of 25.3 degrees. FIGS. 23 and 24 illustrate the temperature and flow profiles for a modified New Fan Blade with a discharge angle α of 36.0. Although these three modified New Fan Blades are different in performance from one another, the simulated performance of the fans under all three values of flattened trailing edge angles shows marked reductions in shaft power and motor temperature over the conventional fan blade.

The embodiments described above and illustrated in the figures are presented by way of example only and are not intended as a limitation upon the concepts and principles of the present invention. As such, it will be appreciated by one having ordinary skill in the art that various changes in the elements and their configuration and arrangement are possible without departing from the spirit and scope of the present invention as set forth in the appended claims.

What is claimed is:

1. A fan for connection to a motor having an end, an output shaft rotatable about an axis of rotation, and at least one side axially extending from the end of the motor, the fan comprising:
a fan blade shaped to extend axially and radially from the axis of rotation when the fan is installed on the output shaft of the motor, the fan blade comprising
a radially outermost edge;
a radius defined by a circle traced by the radially outermost edge of the fan blade as the fan blade is rotated about the axis of rotation; and
an inner annular portion extending axially past the end of the motor to a location beside the motor, a part of the inner annular portion spaced from the axially extending side by a gap no more than about 0.16 times a largest radial dimension of the motor at an axial location shared by the part of the inner annular portion,
wherein an angle of at least about zero degrees and no greater than about 40 degrees is defined between a first straight line parallel to the axis of rotation and a second straight line passing through a farthest axially downstream point on a trailing edge of the fan blade, tangent to a surface of the fan blade at the point, and tangent to a cylinder coincident with the axis of rotation and in which the point lies.

2. The fan as claimed in claim 1, wherein the radius of the fan blade is no less than about 8 inches and is no greater than about 15 inches.

3. The fan as claimed in claim 1, wherein the gap is no more than about 0.09 times the largest radial dimension of the motor at the axial location.

4. The fan as claimed in claim 1, wherein the gap is no more than about 0.03 times the largest radial dimension of the motor at the axial location.

5. The fan as claimed in claim 1, wherein the fan blade is coupled to the output shaft by a hub adapted to be received on the output shaft of the motor.

6. The fan as claimed in claim 1, wherein:
the fan blade has a plurality of cross-sectional shapes defined at different respective radii of the fan blade; and
the cross-sectional shapes of the fan blade have decreasing camber-to-chord ratios with increasing radial distances from the axis of rotation.

7. The fan as claimed in claim 1, wherein:
the fan blade has a cross-sectional shape defined along a radius of about 0.2 times the radius of the fan blade; and
the cross-sectional shape has a camber-to-chord ratio of between about 0.08 and about 0.18.

8. The fan as claimed in claim 1, wherein:
the fan blade has a cross-sectional shape defined along a radius of about 0.5 times the radius of the fan blade; and
the cross-sectional shape has a camber-to-chord ratio of between about 0.07 and about 0.14.

9. The fan as claimed in claim 1, wherein:
the fan blade has a cross-sectional shape defined along a radius of about 0.98 times the radius of the fan blade; and
the cross-sectional shape has a camber-to-chord ratio of between about 0.02 and about 0.06.

10. The fan as claimed in claim 1, wherein the angle is at least about 0 degrees and is no greater than about 20 degrees.

11. The fan as claimed in claim 1, wherein the angle is at least about 0 degrees and is no greater than about 8 degrees.

12. The fan as claimed in claim 1, wherein a second angle of at least about 12 degrees and no greater than about 32 degrees is defined between a plane substantially orthogonal to the axis of rotation and a third straight line extending through a leading edge of the fan blade and the trailing edge of the fan blade at a tip of the fan blade.

13. The fan as claimed in claim 12, wherein the second angle is at least about 12 degrees and is no greater than about 24 degrees.

14. The fan as claimed in claim 12, wherein the second angle is at least about 12 degrees and is no greater than about 18 degrees.

15. The fan as claimed in claim 1, wherein:
a plurality of additional angles are defined between a plane substantially orthogonal to the axis of rotation and respective additional straight lines each extending through a leading edge and the trailing edge of the fan blade at different radii of the fan blade; and
the plurality of additional angles decrease in size with increasing radial distance from the axis of rotation; and
the decrease in size is at least 10 degrees along substantially the entire length of the fan blade.

16. A fan for connection to a motor having an end, the fan comprising:
a fan blade adapted to be coupled to the motor, rotatable about an axis of rotation, and extending radially and axially from the axis of rotation when coupled to the motor, the fan blade comprising
a peripheral edge comprising
a radially outermost edge;
a leading edge; and
a trailing edge;
at least part of the peripheral edge extending axially past the end of the motor to an axial location beside the motor, wherein the at least part of the peripheral edge is separated from the motor at the axial location by a gap no greater than about 0.16 times a largest radial dimension of the motor at the axial location;
a radius defined by a circle traced by the radially outermost edge of the fan blade as the fan blade is rotated about the axis of rotation;
a first point on the leading edge at a tip of the fan blade; and
a second point on the trailing edge at a tip of the fan blade;
wherein a first angle of at least about 12 degrees and no greater than about 32 degrees is defined between a plane substantially orthogonal to the axis of rotation and a first straight line extending through the first and second points; and
wherein a second angle of at least about zero degrees and no greater than about 40 degrees is defined between a second straight line parallel to the axis of rotation and a third straight line passing through a third point at a radially innermost farthest axially downstream point on the fan blade, tangent to a surface of the fan blade at the third point, and tangent to a cylinder coincident with the axis of rotation and in which the third point lies.

17. The fan as claimed in claim 16, wherein the radius of the fan blade is no less than about 8 inches and is no greater than about 15 inches.

18. The fan as claimed in claim 16, wherein the gap is no greater than about 0.09 times the largest radial dimension of the motor at the axial location.

19. The fan as claimed in claim 16, wherein the gap is no greater than about 0.03 times the largest radial dimension of the motor at the axial location.

20. The fan as claimed in claim 16, wherein the fan blade is coupled to an output shaft of the motor via a hub.

21. The fan as claimed in claim 16, wherein:
the fan blade has a plurality of cross-sectional shapes defined at different respective radii of the fan blade; and
the cross-sectional shapes of the fan blade have decreasing camber-to-chord ratios with increasing radial distances from the axis of rotation.

22. The fan as claimed in claim 16, wherein the first angle is at least about 12 degrees and is no greater than about 24 degrees.

23. The fan as claimed in claim 16, wherein the first angle is at least about 12 degrees and is no greater than about 18 degrees.

24. The fan as claimed in claim 16, wherein the second angle is at least about zero degrees and is no greater than about 20 degrees.

25. The fan as claimed in claim 16, wherein the second angle is at least about zero degrees and is no greater than about 8 degrees.

26. The fan as claimed in claim 16, wherein:
a plurality of twist angles are defined between the plane and respective straight lines each extending through the leading and trailing edges of the fan blade at different radii of the fan blade; and
the twist angles decrease in size with increasing radial distance from the axis of rotation; and
the decrease in size is at least 10 degrees along substantially the entire length of the fan blade.

27. The fan as claimed in claim 16, wherein:
the fan blade has a cross-sectional shape defined along a radius of about 0.2 times the radius of the fan blade; and
the cross-sectional shape has a camber-to-chord ratio of between about 0.08 and about 0.18.

28. The fan as claimed in claim 16, wherein:
the fan blade has a cross-sectional shape defined along a radius of about 0.5 times the radius of the fan blade; and
the cross-sectional shape has a camber-to-chord ratio of between about 0.07 and about 0.14.

29. The fan as claimed in claim 16, wherein:
the fan blade has a cross-sectional shape defined along a radius of about 0.98 times the radius of the fan blade; and
the cross-sectional shape has a camber-to-chord ratio of between about 0.02 and about 0.06.

30. A fan assembly for connection to a motor having opposite ends, the fan assembly comprising:
a fan blade adapted to be coupled to the motor for rotation about an axis of rotation, the fan blade comprising
a leading edge; and
a trailing edge;
at least a portion of the trailing edge located an axial distance from at least a portion of the leading edge;
wherein rotation of the fan blade in an installed position on the motor defines an annular volume through which the fan blade passes, the annular volume having a radius and a hollow interior;
at least a portion of the motor is received within the hollow interior when the fan is in an installed position on the motor;
at least one portion of the annular volume is located between the opposite ends of the motor, and is separated from the motor at an axial location by a gap no more than about 0.16 times a largest radial dimension of the motor at the axial location; and
an angle of at least about zero degrees and no greater than about 40 degrees is defined between a first straight line parallel to the axis of rotation and a second straight line passing through a farthest axially downstream point on the trailing edge of the fan blade, tangent to a surface of the fan blade at the point, and tangent to a cylinder coincident with the axis of rotation and in which the point lies.

31. The fan as claimed in claim 30, wherein the radius of the annular volume is no less than about 8 inches and is no greater than about 15 inches.

32. The fan as claimed in claim 30, wherein the gap is no more than about 0.09 times the largest radial dimension of the motor at the axial location.

33. The fan as claimed in claim 30, wherein the gap is no more than about 0.03 times the largest radial dimension of the motor at the axial location.

34. The fan as claimed in claim 30, wherein the fan blade is coupled to an output shaft of the motor by a hub.

35. The fan as claimed in claim 30, wherein:
the fan blade has a plurality of cross-sectional shapes defined at different respective radii of the fan blade; and
the cross-sectional shapes of the fan blade have decreasing camber-to-chord ratios with increasing radial distances from the axis of rotation.

36. The fan as claimed in claim 30, wherein the angle is at least about zero degrees and is no greater than about 20 degrees.

37. The fan as claimed in claim 30, wherein the angle is at least about zero degrees and is no greater than about 8 degrees.

38. The fan as claimed in claim 30, wherein a second angle of at least 12 about degrees and no greater than about 32 degrees is defined between a plane substantially orthogonal to the axis of rotation and a third straight line extending through the leading and trailing edges of the fan blade at the radius of the annular volume.

39. The fan as claimed in claim 38, wherein the second angle is at least about 12 degrees and is no greater than about 24 degrees.

40. The fan as claimed in claim 38, wherein the second angle is at least about 12 degrees and is no greater than about 18 degrees.

41. The fan as claimed in claim 30, wherein:
a plurality of additional angles are defined between a plane substantially orthogonal to the axis of rotation and respective additional straight lines each extending through the leading and trailing edges of the fan blade at different radii of the fan blade; and
the additional angles decrease in size with increasing radial distance from the axis of rotation; and
the decrease in size is at least 10 degrees along substantially the entire length of the fan blade.

42. The fan as claimed in claim 30, wherein:
the fan blade has a cross-sectional shape defined along a radius of about 0.2 times the radius of the annular volume; and
the cross-sectional shape has a camber-to-chord ratio of between about 0.08 and about 0.18.

43. The fan as claimed in claim 30, wherein:
the fan blade has a cross-sectional shape defined along a radius of about 0.5 times the radius of the annular volume; and
the cross-sectional shape has a camber-to-chord ratio of between about 0.07 and about 0.14.

44. The fan as claimed in claim 30, wherein:
the fan blade has a cross-sectional shape defined along a radius of about 0.98 times the radius of the annular volume; and
the cross-sectional shape has a camber-to-chord ratio of between about 0.02 and about 0.06.
